(19) United States
(12) Patent Application Publication
(10) Pub. No.: US 2012/0153050 A1
(43) Pub. Date: Jun. 21, 2012

(54) KITCHEN SINK SPRAYER

(76) Inventor: Orlando BOSIO, Casaloldo (IT)

(21) Appl. No.: 13/316,990

(22) Filed: Dec. 12, 2011

(30) Foreign Application Priority Data
Dec. 15, 2010 (IT) MI2010A002289

(51) Int. Cl. B05B 9/00

(52) U.S. Cl. 239/525

(57) ABSTRACT

Kitchen sink sprayer, comprising a body provided at one end with a coupling to a flexible hose extending from a faucet for adjusting the flow-rate and connected at its other end to a water outflow plug having an axis inclined with respect to the water flow direction. The body comprises a rod that has at one end a tip adapted to open selectively the access of the water to at least one duct for forming a central jet and to at least one duct for forming a peripheral jet, and has means for actuation by the user. The means for actuation of the rod comprise a tab connected directly to the rod and protruding from the body's enclosure to an extent that is sufficient for contact gripping by the user, in a position located in proximity to the end for entry of the water into the sprayer.

### BACKGROUND OF THE INVENTION

This application claims priority from Italian Patent Application No. MI2010A002289, filed Dec. 15, 2010, the disclosures of which are incorporated herein by reference.

### BACKGROUND OF THE INVENTION

It is known that many faucets installed on kitchen sinks for supplying water and adjusting the flow thereof between open and closed end positions are provided with a flexible hose, accommodated in an adapted duct, that extends at one end from the faucet proper and is provided at the other end with an element called sprayer which is designed to be gripped by the user in order to achieve two purposes.

First of all the sprayer can be manipulated to bring the flow of water to gush at different points in the sink, and also the sprayer can be set, by way of simple actuation of means with which it is provided, to produce the outflow of water in the form of a central jet or a peripheral jet.

In particular there are sprayers, known as “pull-out” in the field, that comprise a body for conveying the water longitudinally, enclosed in an outer enclosure for gripping by a user.

Such body is provided at one end with a coaxial coupling to the flexible water supply hose that extends from the faucet installed on the sink, accommodated in a duct that leads to the exterior with a section that is substantially horizontal or inclined upwardly, while at the other end the body is connected with a water outflow plug which is located at the side wall of the outer enclosure and has an axis which is inclined with respect to the longitudinal axis of the body.

Inside such body a rod is comprised that has at one end a tip which is adapted to open selectively the access of the water to ducts for forming the central jet and to ducts for forming the peripheral jet, and is provided with actuation means that usually make it possible for the user to move it from one to the other of the two selection positions and vice versa.

The means for actuation of the rod which are present in the known art all suffer a certain complexity of construction and consequently are rather cumbersome, and moreover they do not offer the user the best conditions for wielding the sprayer.

In fact they are located at the water outflow end or in proximity thereto, and thus the user is forced to grip the sprayer in such a way that he/she is required to twist it around in order to be able to wield it advantageously.

### SUMMARY OF THE INVENTION

The aim of the present invention is to provide a sprayer of the “pull-out” type in which the encumbrance of the means for actuation of the rod is reduced to the minimum, so as to enable a miniaturization of the sprayer taken to the maximum extreme, and which moreover is such as to allow the maximum convenience of handling by the user.

This aim is achieved by an improved kitchen sink sprayer, according to the invention, characterized in that it comprises the features disclosed in the appended claims.

### BRIEF DESCRIPTION OF THE DRAWINGS

Further characteristics and advantages of the invention will become better apparent from the detailed description of a preferred, but not exclusive, embodiment of the invention, illustrated by way of non-limiting example in the accompanying drawings, wherein:

FIG. 1 is a perspective view of the sprayer connected to one end of the flexible hose accommodated in the adapted duct extending from a faucet (not visible in the figure), in a situation of being used by a user;

FIGS. 2 and 3 are sectional views of the sprayer respectively in the central jet configuration and in the peripheral jet configuration.

### DESCRIPTION OF THE PREFERRED EMBODIMENTS

With reference to the figures, the reference numeral 1 generally designates the sprayer connected by means of the coupling 2 to one end of the flexible hose 3 which is accommodated in the adapted duct 4 and extends at the other end from a faucet, not visible in the figures, that controls the flow-rate of water between the two end positions of completely open and closed.

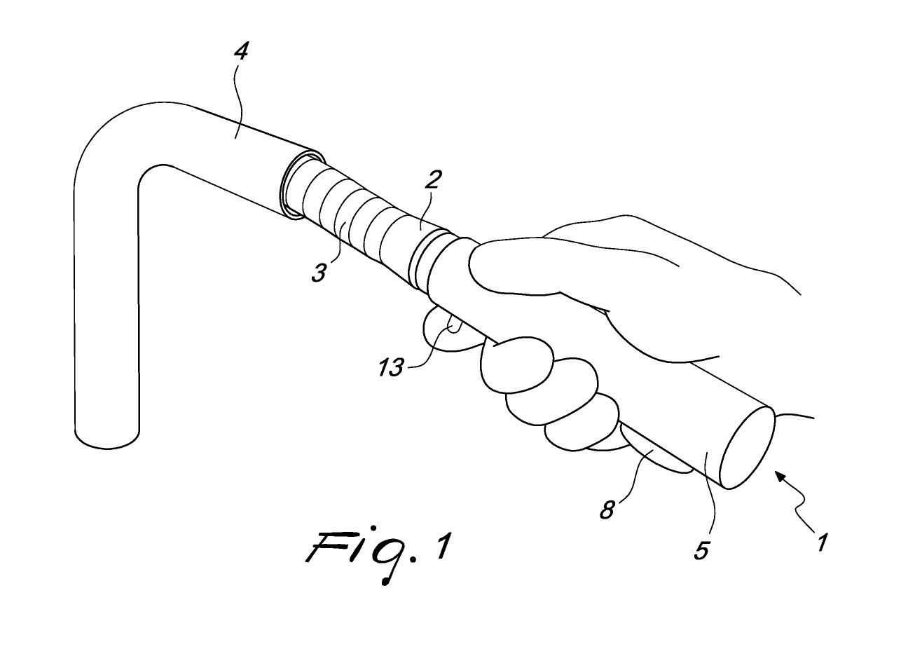

The sprayer 1 comprises the outer enclosure 5 for gripping by the user, as shown in FIG. 1, inside which a composite body is provided that in turn comprises three main elements, and specifically: a first element 6 on the water inlet side, provided with a threading 6a mated with a coupling 2, and fixed to an outer enclosure 5 by means of a threaded grub screw 5a, a second element 7 associated with a plug 8 that keeps it in position inside the outer enclosure 5 and comprises a duct 9 provided with an aerator 9a for providing the outflow of the water in the form of a central jet and ducts such as 10a, 10b for forming a peripheral jet, and finally a central element 11.

Advantageously, the presence of the central element 11 means that all the elements can be provided with shapes that are particularly simple and easy to make, and such as to ensure high-performing functional characteristics at the same time.

In the “pull-out” sprayer shown in the figures, the axis of the plug 8 has an angle of inclination with respect to the longitudinal axis of the sprayer of 90°, but inclinations of between 60° and 120° are usual.

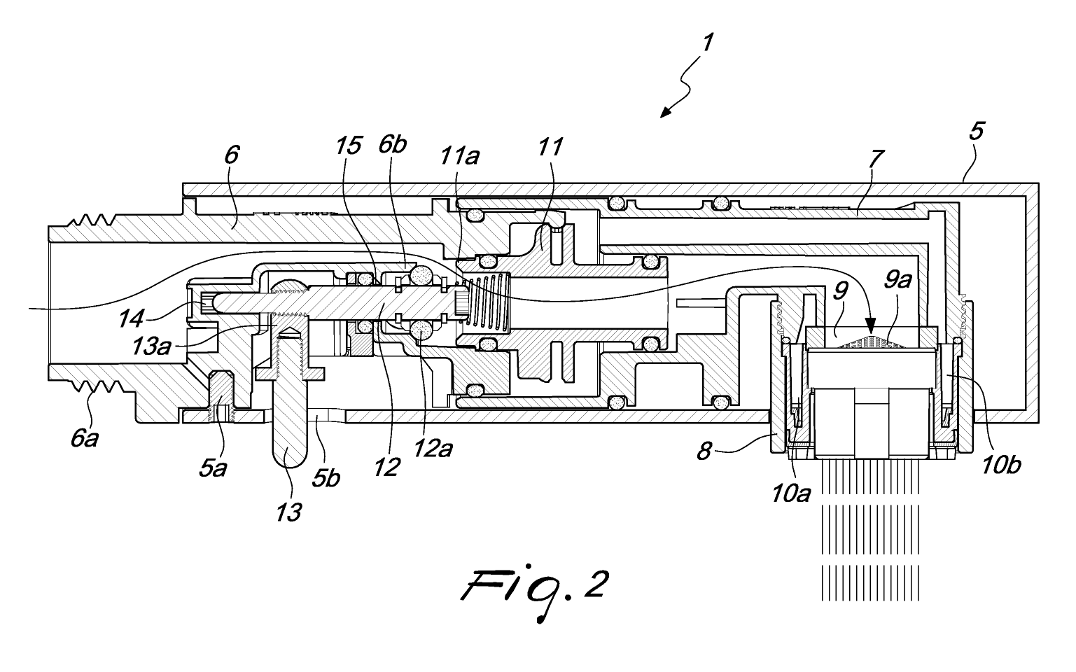

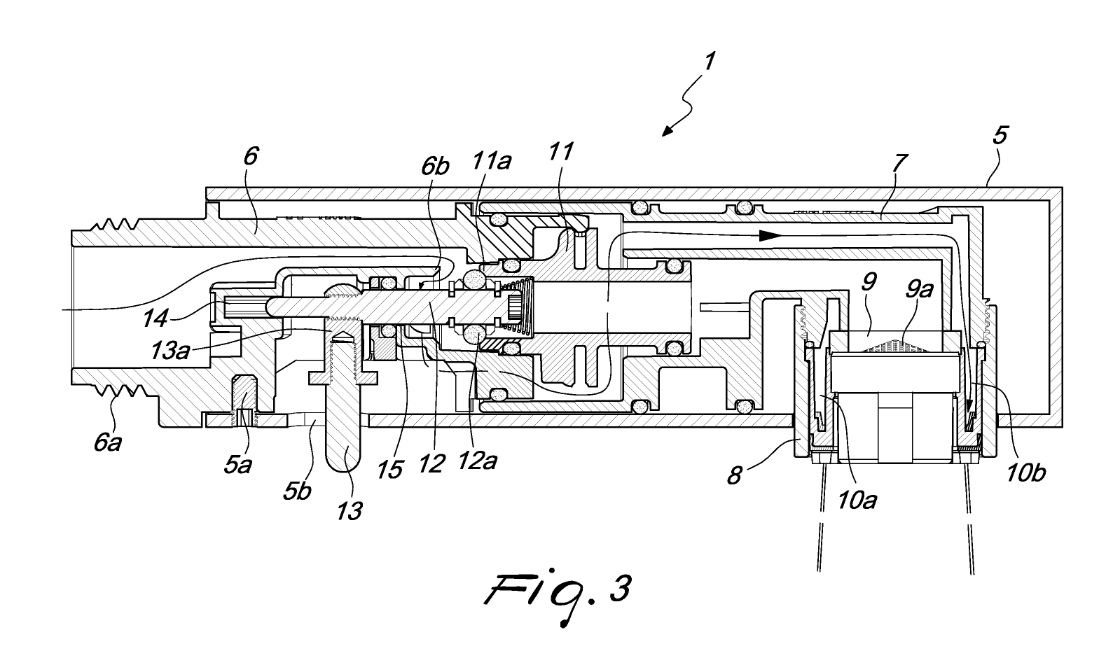

The reference numeral 12 designates a rod which has the tip provided with a gasket 12a and adapted to assume, following actuation applied by the operator on the rod 12, the two positions shown respectively in FIG. 2, with a gasket 12a in contact with a seal seat 6b formed in the element 6, and in FIG. 3, with the gasket 12a in contact with a seal seat 11a defined in the element 11, so as to open selectively the access of the water, indicated by arrows in the figures, to the duct 9 in order to provide the central jet, which is shown in FIG. 2, and to the ducts 10a, 10b in order to provide the peripheral jet, which is shown in FIG. 3.

The means for actuation of the rod 12 comprise a tab 13 connected thereto by means of a threaded bushing 13a and protruding from the outer enclosure 5 at a slot 5b to an extent that is sufficient for contact gripping by the user, in a position that is located very close to the end for entry of the water into the sprayer.

It should be noted that the slot that allows the tab 13 to protrude from the enclosure 5 can be arranged in any position along the circumference of the enclosure.

The rod 12 is guided in its movements by guiding means, constituted by a seat 14 that accommodates the end of the rod proper and by the walls of a hole 15, which are arranged on opposite sides with respect to the coupling position of the tab 13, so as to offer maximum effectiveness.

From the foregoing description it is evident that the means for actuating the rod 12 are exceptionally simple; it is therefore possible to achieve a reduction in encumbrance of the sprayer to levels which could not be possible when adopting means of the type offered by the known art, and merely as an example, the adoption of the means according to the invention has made it possible to make a cylindrical “pull-out” sprayer with a diameter of 28 mm.

Also, the particular positioning of the tab 13 located very close to the entry of the water into the sprayer creates the best conditions for wielding it by the user, as made evident by the deployment of the hand shown in FIG. 1 which shows how, once the sprayer is gripped in a natural manner, by having a finger in contact with the tab 13, the user can work with the sprayer immediately without having to resort to any convolutions.

The invention described is susceptible of numerous modifications and variations, all of which are within the scope of the appended claims. The tab 13 can for example be made integral with the rod 12 in any manner, and moreover nothing changes if the sprayer comprises, in a known manner, a spring that automatically returns it to the central jet position from the peripheral jet position when the faucet is closed.

What is claimed is:

1. A kitchen sink sprayer, comprising a body enclosed in an outer enclosure for gripping by a user, provided at one end with a coaxial coupling to a flexible water supply hose which extends from a faucet for adjusting the flow-rate between an open position and a closed position, and is connected, at its other end, to a water outflow plug, which is located at the side wall of the outer enclosure and has an axis which is inclined with respect to the longitudinal axis of the body that represents the direction of the flow of the water in said body, said body comprising internally a rod which has, at one end, a tip which is adapted to open selectively the access of the water to at least one duct for forming a central jet and to at least one duct for forming a peripheral jet, and is provided with means for actuation by the user, wherein said means for the actuation of said rod comprise a tab which is connected directly to said rod and protrudes from said outer enclosure of the sprayer to an extent that is sufficient for contact gripping by the user, in a position located proximate to the end for entry of the water into said sprayer .

2. The sprayer according to claim 1, further comprising means for guiding said rod in its motion which are arranged on opposite sides with respect to the coupling position of said tab on said rod.

3. The sprayer according to claim 1, wherein said tab of said rod is connected to said rod by means of threading.

4. The sprayer according to claim 1, wherein said tab of said rod protrudes from said outer enclosure of the sprayer at a slot provided in said enclosure.

5. The sprayer according to claim 1, wherein the body enclosed in said outer enclosure has a composite shape, which comprises at least three main elements: a first element on the water inlet side, a second element associated with said water outflow plug, and a third element located in a position which is intermediate with respect to the first two.

6. The sprayer according to claim 5, wherein the first and third elements (6, 11) comprise respectively the sealing seats designed to make contact selectively with the gasket that is present on the tip of said rod (12).
